(19) United States
(12) Patent Application Publication
(10) Pub. No.: US 2005/0157955 A1
(43) Pub. Date: Jul. 21, 2005

(54) Self-contained OCR system using hard disk drive

(75) Inventors: Joseph A. Cervantes, Mountain View, CA (US); Walton Fong, San Jose, CA (US); Donald Ray Gillis, San Jose, CA (US); Remmelt Pit, Cupertino, CA (US)

Correspondence Address: John L. Rogitz;Rogitz & Associates, Suite 3120, 750 B Street, San Diego, CA, 92101, US

(73) Assignee: Hitachi Global Storage Technologies, Amsterdam (NL)

(21) Appl. No.: 10/758,662

(22) Filed: Jan. 15, 2004

(51) Int. Cl. G06K 7/10

(52) U.S. Cl. 382/321

(57) ABSTRACT

A self-contained OCR system includes a housing holding a scanner for outputting a digitized representation of information on paper documents, and a processor in the housing for executing an OCR module to generate ASCII text from the digitized representation. The housing also holds a hard disk drive for storing the text. External devices are not needed to transform the paper-borne text to electronically-stored text.

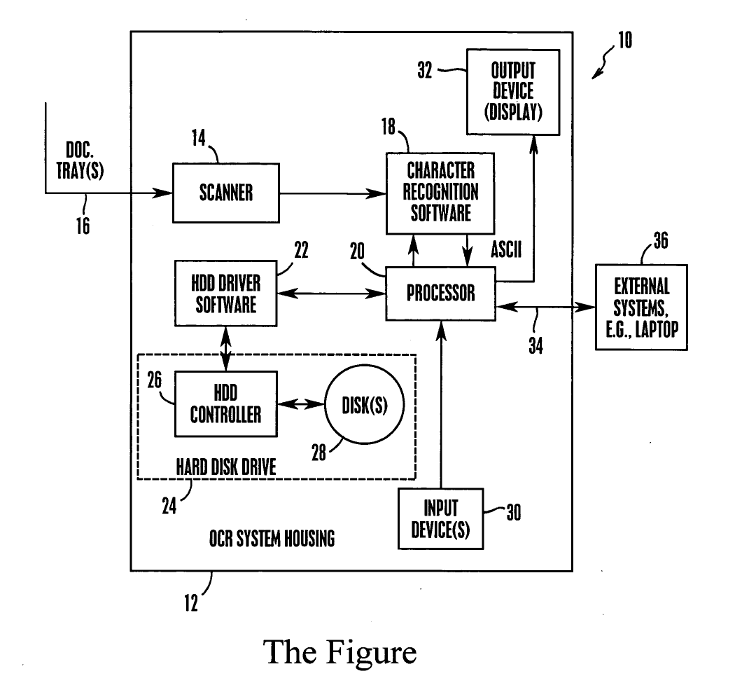

### FIELD OF THE INVENTION

The present invention relates to optical character recognition (OCR) systems.

### BACKGROUND

Optical character recognition (OCR) systems typically include a scanner for digitizing information on a sheet of paper, and character recognition software receiving the digitized information from the scanner and converting it to ASCII text representing alpha-numeric characters that can be electronically stored. The text can then be input to or used by other programs as desired.

Existing OCR systems are not self-contained, in that the scanner generally is separate from the character recognition software, which is typically loaded into and executed by a user's computer that is electrically connected to the scanner. For this reason, existing OCR systems are not portable, as might otherwise be desired for, e.g., mobile applications. With this recognition in mind, the invention herein is provided.

### SUMMARY OF THE INVENTION

A self-contained character recognition system includes a housing configured for receiving paper documents and a scanner in the housing for outputting a digitized representation of information on the paper documents. A processor in the housing executes a character recognition module for converting the digitized representation into electronic text, with the electronic text being stored on a hard disk drive (HDD) in the housing.

Preferably, a HDD driver is executable by the processor for communicating with the HDD. Also, the HDD may include a HDD controller and at least one data storage disk. The HDD may be removable from the housing. An output bus can be provided on the housing for transferring data on the HDD to an external computing device.

In one implementation, the processor automatically executes the character recognition module upon scanning a document and stores the electronic text in the HDD, without the need for a user command. In another implementation, the housing can include a user input device and if desired an output device such as a display.

In another aspect, a method for converting text on paper to electronic form includes providing a single housing holding a scanner, a processor accessing a character recognition module, and a hard disk drive (HDD). The method includes feeding a paper document into the housing, scanning the paper document using the scanner, and converting an output of the scanner into electronic text using the character recognition module. The electronic text is stored on the HDD.

In yet another aspect, a portable scanner system includes a scanner in a housing for scanning printed text on paper documents. A hard disk drive (HDD) is also in the housing. A processor is interposed between the scanner and HDD within the housing to generate an electronic version of the paper text and store the electronic version on the HDD.

The details of the present invention, both as to its structure and operation, can best be understood in reference to the accompanying drawings, in which like reference numerals refer to like parts, and in which:

### BRIEF DESCRIPTION OF THE DRAWINGS

The FIGURE is a block diagram of the present self-contained OCR system.

### DETAILED DESCRIPTION OF THE PREFERRED EMBODIMENT

Referring now to the FIGURE, a self-contained optical character recognition (OCR) system is shown, generally designated 10, which includes an OCR system housing 12 that holds a scanner 14. The scanner 14 can receive paper documents from, e.g., a document tray or trays 16 that can automatically feed documents into the scanner 14 if desired. The scanner 14 outputs a digitized representation of printed information contained on the paper documents in accordance with scanning principles known in the art.

Instead of sending the digitized representation to an external personal computer that runs OCR software, however, the FIGURE shows that the digitized information is sent to a preferably software-implemented character recognition module 18 that is executed by a processor 20 within the housing 12. In accordance with character recognition principles known in the art, the character recognition module 18 outputs ASCII text based on the digitized representation from the scanner 14. The processor 20 can access a preferably software-implemented hard disk drive driver 22 to store the data generated by the character recognition module 18 in a hard disk drive (HDD) 24, which may include a HDD controller 26 and one or more storage disks 28. The character recognition module 18 and hard disk drive driver 22 may be stored in the memory of the processor 20. In one non-limiting implementation, the HDD 24 is a removable HDD, in that it may be engaged and disengaged by hand with the housing 12.

If desired, one or more input devices 30 such as keypads, mice, joysticks, and the like may be provided on or attached to the housing 12 to allow a user to input commands to the processor 20. Also, one or more output devices 32 such as a display may also be provided on the housing 12, so that a user can view the recognized characters and perform edit operations and other operations related to OCR.

The processor 20 may communicate over an output bus 34 with external systems 36, such as laptop computers and the like. The output bus 34 may be a universal serial bus (USB), other type of serial bus, firewire bus, ethernet, or other appropriate data bus.

In one embodiment, when a paper document is engaged with the system 10 it is automatically scanned and characters are automatically processed by the character recognition module 18 and then stored in the HDD 24, without any user interaction apart from feeding the documents into the system 10. In this way, paper-borne text is automatically converted to electronically-stored text by a single self-contained system without the need for a user to input computer commands. In such an embodiment, no input device 30 or output device 32 need be provided. In another embodiment, the user may operate the input device 30 to invoke the character recognition module 18 after the paper documents have been scanned.

In any case, it may be appreciated that the OCR system 10 is self-contained in that paper documents may be scanned and alpha-numeric characters on the documents recognized and electronically stored for further use, without the need for a separate dedicated computer. The electronically-stored characters are then available to the external systems 36 as needed over the output bus 34.

While the particular SELF-CONTAINED OCR SYSTEM USING HARD DISK DRIVE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. § 112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A self-contained character recognition system, comprising:
a housing configured for receiving at least one paper document;
a scanner in the housing outputting a digitized representation of information on the paper document;
a processor in the housing and executing a character recognition module for converting the digitized representation into electronic text; and
at least one hard disk drive (HDD) in the housing for storing the electronic text.

2. The system of claim 1, further comprising a HDD driver executable by the processor for communicating with the HDD.

3. The system of claim 1, wherein the HDD includes a HDD controller and at least one data storage disk.

4. The system of claim 1, wherein the HDD is removable from the housing.

5. The system of claim 1, further comprising an output bus on the housing for transferring data on the HDD to an external computing device.

6. The system of claim 1, wherein the processor automatically executes the character recognition module upon scanning a document and stores the electronic text in the HDD, without the need for a user command.

7. The system of claim 1, further comprising:
at least one input device engaged with the housing; and
at least one output device on the housing.

8. A method for converting text on paper to electronic form, comprising:
providing a single housing holding a scanner, a processor accessing a character recognition module, and at least one hard disk drive (HDD);
feeding at least one paper document into the housing;
scanning the paper document using the scanner;
converting an output of the scanner into electronic text using the character recognition module; and
storing the electronic text on the HDD.

9. The method of claim 8, wherein the converting act is automatically executed by the processor in response to the scanning act.

10. A portable scanner system, comprising:
a scanner in a housing for scanning printed text on paper documents;
a hard disk drive (HDD) in the housing; and
a processor interposed between the scanner and HDD within the housing to generate an electronic version of the paper text and store the electronic version on the HDD.

11. The system of claim 10, further comprising a character recognition module for converting the digitized representation into electronic text, the character recognition module being executable by the processor.

12. The system of claim 11, further comprising a hard disk drive driver executable by the processor for communicating with the HDD.

13. The system of claim 11, wherein the HDD includes a HDD controller and at least one data storage disk.

14. The system of claim 11, wherein the HDD is removable from the housing.

15. The system of claim 11, further comprising an output bus on the housing for transferring data on the HDD to an external computing device.

16. The system of claim 11, wherein the processor automatically executes the character recognition module upon scanning a document and stores the electronic version in the HDD, without the need for a user command.

17. The system of claim 11, further comprising:
at least one input device engaged with the housing; and
at least one output device on the housing.
